(19) United States
(12) Patent Application Publication
(10) Pub. No.: US 2013/0120273 A1
(43) Pub. Date: May 16, 2013

(54) APPARATUS AND METHOD FOR INPUTTING

(71) Applicants: Myung Ryul Choi, Seoul (KR); Nag Eui Choi, Suwon-si (KR)

(72) Inventors: Myung Ryul Choi, Seoul (KR); Nag Eui Choi, Suwon-si (KR)

(21) Appl. No.: 13/674,270

(22) Filed: Nov. 12, 2012

(30) Foreign Application Priority Data
Nov. 10, 2011 (KR) 10-2011-0117034

(51) Int. Cl. G06F 3/023; G06F 3/02

(52) U.S. Cl. CPC G06F 3/023; G06F 3/02
USPC 345/168

(57) ABSTRACT

An input apparatus and method are provided. The input apparatus includes an input unit that includes at least one key. The input unit may receive at least one input coordinate corresponding to the at least one key. The apparatus also includes a control unit to update a key area of the input unit based on the at least one input coordinate.

### CROSS-REFERENCE TO RELATED APPLICATION(S)

This application claims the benefit under 35 USC §119(a) of Korean Patent Application No. 10-2011-0117034, filed on Nov. 10, 2011, in the Korean Intellectual Property Office, the entire disclosure of which is incorporated herein by reference for all purposes.

### BACKGROUND

1. Field

The following description relates to an apparatus and method for inputting, and more particularly, to an input apparatus and method for preventing an incorrect input from being selected.

2. Description of Related Art

Today, touch screens are included in various devices from simple office devices to multifunctional mobile devices. For example, input of text is indispensable in a mobile device. To implement various functions, the text input method using the touch screen of a mobile device should be quick and efficient.

Keyboards in various key arrays have been introduced in mobile devices for users to select suitable keyboards and use the various functions of the mobile device. However, typically a touch screen differs from a mechanical keyboard that includes special keys detectable by tactile sense, such as an F-key and a J-key having a protrusion, whereas the touch screen does not typically include such special keys. Furthermore, because of the small size of individual keys in a mobile device, the incorrect selection of keys is relatively high when using the touch screen.

KR Patent Laid-open No. 10-2009-0025610 describes an example of an apparatus for quick input of text. However, the technology is limited to quick input of text using a key array and an input system. As a result, the uncorrected typing rate is still not improved.

### SUMMARY

In an aspect, there is provided an input apparatus including an input unit comprising at least one key and configured to receive at least one input coordinate corresponding to the at least one key, and a control unit configured to update a key area of the input unit based on the at least one input coordinate.

The input unit may comprises a first input unit that is displayed on a screen and a second input unit that is not displayed on the screen, the second input unit may be configured to receive the at least one input coordinate, and the control unit may be configured to update the key area of the second input unit.

The first input unit may comprise a keyboard displayed on a touch screen, and the second input unit may comprise a key area of a virtual key that is different in location from a key area of the at least one key of the first input unit, in an input area including the keyboard on the touch screen.

The second input unit may be selectively displayed on the screen.

The control unit may be configured to update the key area of the input unit based on a correct typing coordinate input by correct typing by the user.

The correct typing coordinate may comprise an input coordinate of an uncorrected key code from among the at least one input coordinates.

The control unit may be configured to update the key area of the input unit such that the correct typing coordinate is included in the key area.

The control unit may be configured to update the key area of the input unit based on an input pattern obtained by analyzing the correct typing coordinate.

The control unit may be configured to update the key area such that an average coordinate of the correct typing coordinates with respect to the key becomes a center of the key area.

The control unit may comprise an error calculation unit configured to calculate a relative coordinate (xr=xt−xk, yr=yt−yk) of an input coordinate (xt, yt) and a center coordinate (xk, yk) of the key area, the relative coordinate corresponding to a difference between the input coordinate (xt, yt) and the center coordinate (xk, yk), and the control unit is configured to update the key area of the input unit based on the calculated relative coordinate.

The input apparatus may further comprise a table generation unit configured to determine whether a key code generated by the input coordinate is corrected and to add the relative coordinate to a distribution table in response to the key code not being corrected, and an area update unit configured to determine an average of relative coordinates added to the distribution table to be a new center coordinate (xk1, yk1) in response to a number of the relative coordinates added to the distribution table satisfying a preset value.

The area update unit may be configured to update a boundary of the key area based on an input pattern recognized from the relative coordinate added to the distribution table.

The control unit may be configured to expand at least one of a boundary of the key area and a boundary of a neighboring key area until the boundaries touch each other, in response to the boundaries not being separated from each other.

The control unit may be configured to update a key area of a key different from a key of which the input coordinate is received.

In an aspect, there is provided an input apparatus including an input key display unit configured to display an input key in a display space, and a key code unit configured to set a manipulation area assigned to the key code of the input key at a different area from an area of the input key in the display space.

The manipulation area may be manipulated by an error during manipulation of the input key.

In an aspect, there is provided an input apparatus including an input unit comprising a key assigned with a key code and configured to output the key code assigned to the key in response to the key being input, and a control unit configured to update a key area of the key based on an input coordinate of the key of which an uncorrected key code among output key codes is output.

In an aspect, there is provided an input method including displaying a keyboard on a touch screen, recognizing a touch pattern from distribution of touched positions input by correct typing to an input area that includes the keyboard, and updating a key area that outputs a key code of the keyboard based on the recognized touch pattern.

The keyboard may comprise a first keyboard displayed on the touch screen and a second keyboard outputting the key code.

Other features and aspects will be apparent from the following detailed description, the drawings, and the claims.

### BRIEF DESCRIPTION OF THE DRAWINGS

FIG. 1 is a diagram illustrating an example of an input apparatus.

FIG. 2 is a diagram illustrating an example of an input unit of an input apparatus.

FIG. 3 is a diagram illustrating an example of a function of a control unit included in an input apparatus.

FIG. 4 is a diagram illustrating another example of an input apparatus.

FIG. 5 is a diagram illustrating an example of an incorrect typing.

FIG. 6 is a diagram illustrating another example of an input apparatus.

FIG. 7 is a diagram illustrating an example of a method of updating a key area using correct typing.

FIG. 8 is a diagram illustrating an example of a method of updating a key area in an input apparatus.

FIG. 9 is a diagram illustrating an example of a control unit of an input apparatus.

FIG. 10 is a diagram illustrating an example of a process of expanding a boundary of a key area by a control unit in an input apparatus.

FIG. 11 is a diagram illustrating an example of an operation of an input apparatus.

FIG. 12 is a diagram illustrating another example of an input apparatus.

FIG. 13 is a flowchart illustrating an example of an input method.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following detailed description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, description of well-known functions and constructions may be omitted for increased clarity and conciseness.

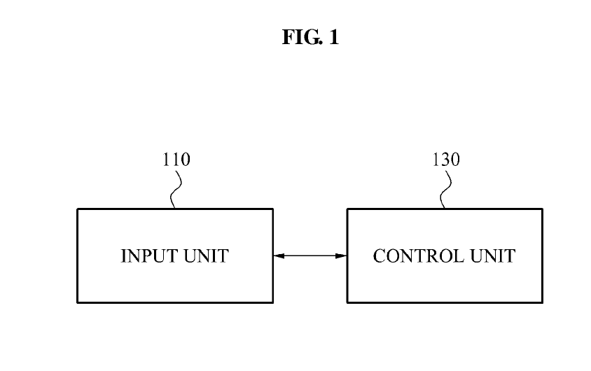

FIG. 1 illustrates an example an input apparatus.

Referring to FIG. 1, the input apparatus includes an input unit 110 including at least one key for receiving input of an input coordinate corresponding to the at least one key, and a control unit 130 to update a key area of the input unit 110 according to the input coordinate.

For example, the input unit 110 may generate a key code to be provided to a system that is connected with the input unit 110. Here, the input unit 110 may be a keyboard, a key pad, and the like provided with at least one key. In general, each key provided to an input unit has an area of size for manipulation by a user. In this case, the same key code may be generated irrespective of the area being manipulated. The input unit 110 of the input apparatus of FIG. 1 may perform the foregoing function as a general function.

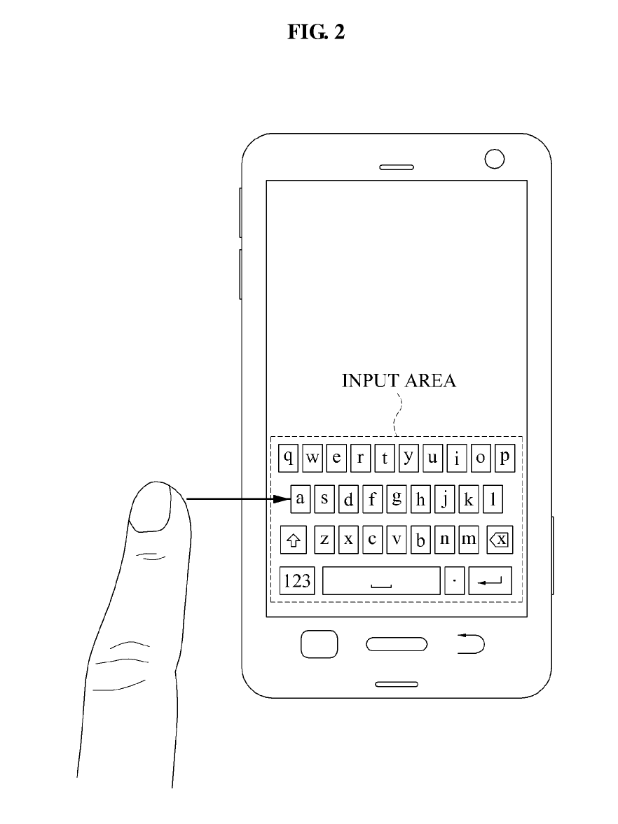

When the user manipulates a key area of the input unit 110, a manipulation position, that is, the input coordinate is input to a key. As an example, a smart phone including a touch screen as the input unit 110 is illustrated in FIG. 2.

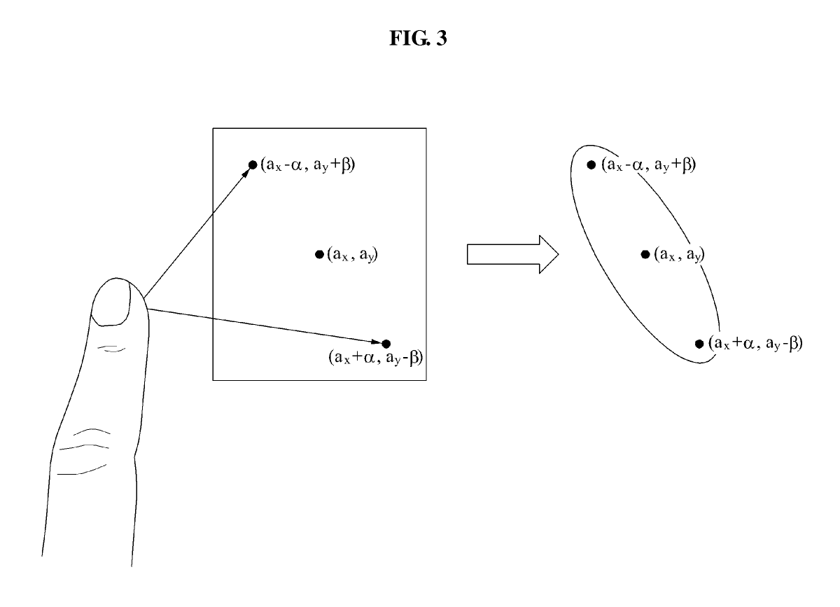

Referring to FIG. 2, the input unit is a keyboard having a QWERTY array. For example, if the user touches key ‘a’ irrespective of the input coordinate, a key code assigned to the key ‘a’ is generated. In this example, a central coordinate of key ‘a’ is (aₓ, a_{y}) as shown in FIG. 3. Accordingly, input coordinates (aₓ−α, a_{y}+β), (aₓ+α, a_{y}−β), and so forth corresponding to an actual touch position are input to an input unit. The input coordinates may be input with respect to the respective keys of the input unit. For example, the input coordinates may be based on a center of each of the respective keys or based on a certain position of each of the respective keys.

The control unit 130 may update the key area of the at least one key provided to the input unit 110 using the input coordinate input by the input unit 110. For example, alphabetical keys provided to the input unit 110 of FIG. 2 are of the same size and shape but differ in positions. The control unit 130 may change the size, shape, and/or positions of the respective alphabetical keys. For example, using two input coordinates as shown in FIG. 3, a rectangular key area of the key ‘a’ may be updated to an oval key area. According to various aspects, the update of the key area may be performed to reduce incorrect typing by a user.

The control unit 130 may estimate an input pattern of a user by analyzing a plurality of input coordinates. Accordingly, the key area of the input unit 110 may be updated according to the input coordinates, and an input unit 110 corresponding to the input pattern of the user may be provided. As a result, incorrect user input may be reduced.

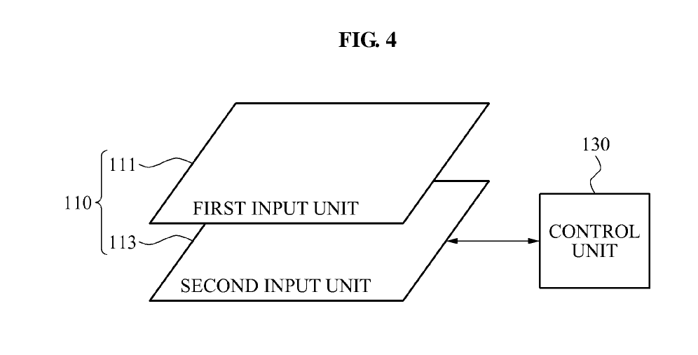

FIG. 4 illustrates another example an input apparatus.

Referring to FIG. 4, the input apparatus includes an input unit 110 and a control unit 130. The input unit 110 may include a first input unit 111 and a second input unit 113.

In the example of the input unit 110 of FIG. 1 that includes a keyboard, the shape, size, and positions of the respective keys displayed on a screen may be changed according to update of the key area. Accordingly, an incorrect typing rate may be reduced. However, incorrect input may still occur.

For example, when the user touches the input unit 110 using a finger, a portion slightly lower from a finger tip is expected to touch the touch screen first. The portion corresponds to a predicted contact portion 115 that is capable of minute manipulation of an object through a concentration of force. Therefore, the user operating the touch screen may move the finger so that a desired key is pressed by the predicted contact portion 115. However, the touch screen reacts to a portion of the finger contacting first irrespective of intensity of the force. Since a human finger tip is round, an actual contact portion 117 that first contacts the touch screen may not be the predicted contact portion 115, but instead may be a portion lower than the predicted contact portion 115.

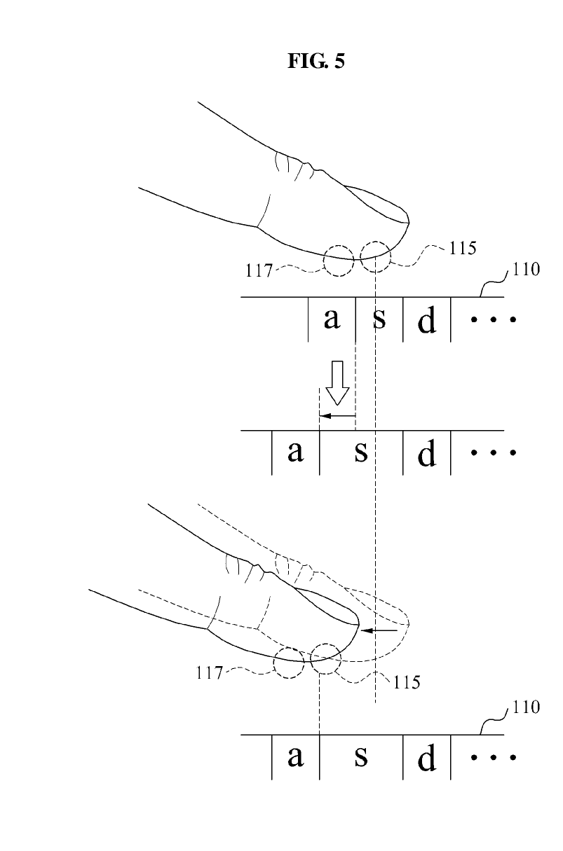

Therefore, although the user intends to touch key ‘s’ in FIG. 5, key ‘a’ neighboring key ‘s’ may be touched instead, thus causing an incorrect typing. To minimize such incorrect typing, a key area of the input unit 110 displayed on the screen may be updated. For example, to reduce uncorrected typing of key ‘s’, the touch region of key ‘s’ may be expanded to include a portion of key ‘a’ as shown in FIG. 5.

However, when a user visually recognizes the expansion of key ‘s’ the user may perform inputting in a usual manner and adjust the location of the touch of the finger on the screen. Accordingly, the user may touch key ‘s’ by moving the finger as much as the expanded area. In this case, in spite of the expansion of the key area, incorrect typing may occur.

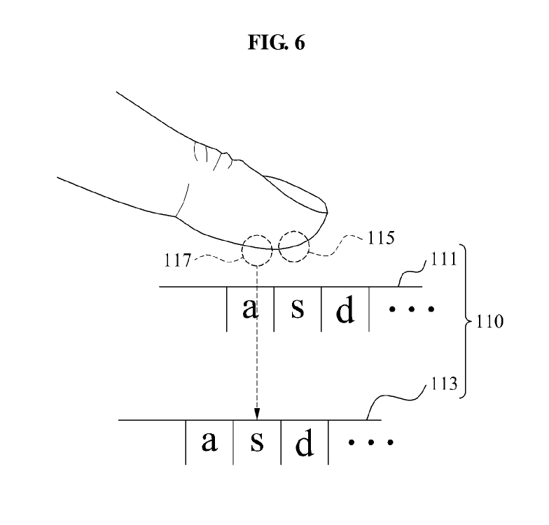

To prevent this, the input unit 110 may include the first input unit 111 displayed to the user and a separate second input unit 113 to generate the key code by touch, as shown in FIG. 6. For example, the first input unit 111 may be displayed on the screen, and the second input unit 113 may not be displayed on the screen but may receive the input coordinate of the user input. In this example, the control unit 130 may update a key area of the second input unit 113 while not updating a key area of the first input unit 111.

For example, the key area of the first input unit 111 displayed on the screen such as the touch screen may not be updated by the input coordinate. Accordingly, the user may visually check the key area of the first input unit 111 and perform touch input as usual. In this case, the key code assigned to the key area of key ‘a’ touched by the actual contact portion 117 is to be output. However, the structure which actually outputs the key code is not the first input unit 111 but rather the second input unit 113. Therefore, the key area of the second input unit 113 may be compared to the key area of the first input unit 111 and moved by a distance between the predicted contact portion 115 and the actual contact portion 117, so that the key code assigned to key ‘s’ touched by the actual contact portion 117 in the second input unit 113 is output. Accordingly, correct typing as intended by the user may be readily achieved.

In FIG. 6, the first input unit 111 and the second input unit 113 are shown as separate for conceptual illustration. However, physically, the first input unit 111 and the second input unit 113 may be integrally formed with each other. For example, a keyboard display on the touch screen may be the first input unit 111. A keyboard assigned with a key area of a virtual key that is different from the key area of the first input unit 111 in an input area including the keyboard of the first input unit 111 may be the second input unit 113. That is, the first input unit 111 and the second input unit 113 may be integrally formed in one device such as the touch screen. As shown in FIG. 2, the second input unit 113 may be disposed in the input area that includes the first input unit 111. It should also be appreciated that the second input unit 113 may be disposed in a separate area.

According to various aspects, the second input unit 113 may also be displayed on the screen depending on a user selection. The displayed second input unit may be various. For example, the second input unit 113 may be displayed in an overlaid state on the first input unit 111. When the second input unit 113 is displayed in this manner, the user may visually check the first input unit 111 and the second input unit 113. Therefore, the user may check his or her actual input pattern with respect to the first input unit 111. Accordingly, the use may recognize a problem in his or her input pattern, and the user may learn a correct input pattern. Consequently, the user may correctly use various existing input apparatuses which are incapable of updating key areas.

In various examples, the input coordinate obtained by the input unit 110 may include an input coordinate generated by correct typing and an input coordinate generated by incorrect typing.

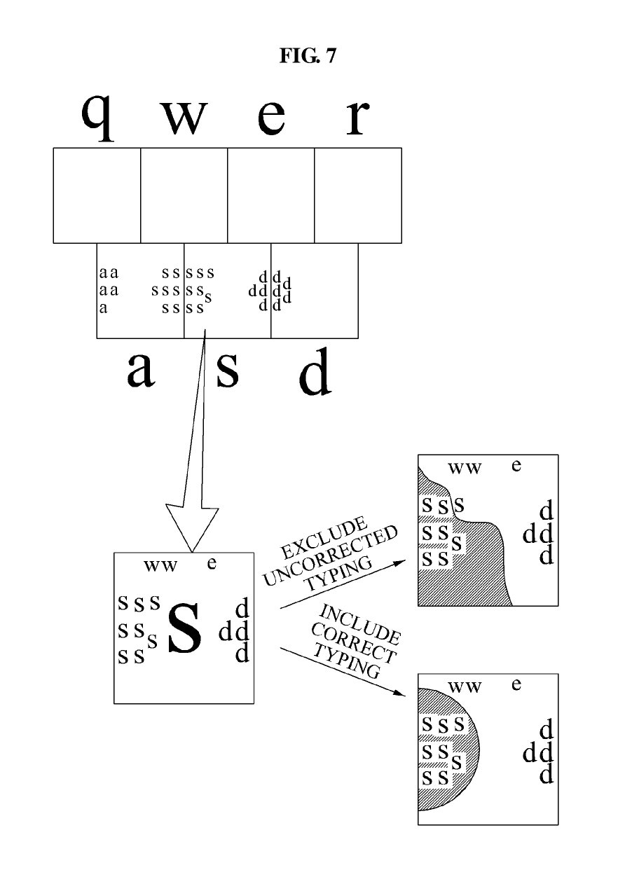

FIG. 7 illustrates an example of an input unit 110 that includes a QWERTY keyboard. Alphabetical letters marked in respective keys of FIG. 7 indicate input coordinates input targeting the input of the corresponding alphabetical letters.

In FIG. 7, the input coordinates obtained from key ‘s’ of the input unit 110 include left input coordinates input targeting key ‘s’ and right input coordinates targeting key ‘d.’Also, upper input coordinates input targeting key ‘w’ and key ‘e’ may be partially included.

Here, input coordinates used for update of the key area of key ‘s’ are the left input coordinates input targeting key ‘s.’ That is, correct typing coordinates input by correct typing of the user may be used for updating the key area. Because the right input coordinates input targeting key ‘d’ are input by the incorrect typing, when the key area is updated from the incorrect typing, an area input by the correct typing may be damaged.

For example, if the key area of key ‘s’ is formed by excluding input coordinates input by the incorrect typing in FIG. 7, even the input coordinates input by the correct typing may be excluded from the key area of key ‘s.’ However, when the key area of key ‘s’ is formed according to the input coordinates input by the correct typing in FIG. 7, such an error may be prevented.

Accordingly, the control unit 130 may update the key area according to the correct typing coordinates input by the correct typing from among the input coordinates received by the input unit 110.

For example, the correct typing coordinates may refer to input coordinates corresponding to an uncorrected key code among key codes generated by the input coordinates. Key codes included in the same key are the same irrespective of the input coordinates. For example, eight input coordinates targeting key ‘s’, two input coordinates targeting key ‘w’, one input coordinate targeting key ‘e’, and four input coordinates targeting key ‘d’ are shown in FIG. 7. Although the input coordinates are respectively different, only the key code assigned to key ‘s’ may be output.

In this example, the user may determine the incorrect typing based on the key code displayed on a display of the system that received the key code from the input unit after manipulation of the input unit. Here, the key code may be transformed into another format. When recognizing the incorrect typing, the user may correct the key code corresponding to the incorrect typing. In the foregoing example, when letters ‘w’, ‘e’, and ‘d’ are output through the display, the user may determine the letters to be the incorrect typing and correct the letters to letter ‘s’. Conversely, the key code may not be corrected with respect to the correct typing. That is, an incorrect key code may be estimated by the correct typing.

According to various aspects, the input apparatus may be equipped with at least one key assigned with the key code, and may include the input unit 110 to output the key code upon input of the at least one key and the control unit 130 to update the key area of the at least one key according to input coordinates of the at least one key of which an incorrect key code is output.

The control unit 130 may update the key area of the input unit 110 using various methods. For example, the control unit 130 may update the key area of the input unit 110 such that the correct typing coordinates are included in the key area of the input unit 110. In this example, the key area may be expanded to a maximum size available in the display device such as the touch screen which provides the input unit 110. However, because key areas of other keys neighboring a corresponding key have their own areas which are not to break into key areas of the other keys, proper key areas may be defined spontaneously.

As another example, the control unit 130 may update the key area of the input unit 110 according to an input pattern that is obtained by analyzing the correct typing coordinates. When various pattern recognition algorithms are applied to a plurality of correct typing coordinates, a pattern of the correct typing coordinates, that is, the input pattern may be obtained. When the key area is updated according to the input pattern, a key area according to the input pattern of the user may be formed. In these examples, various algorithms such as a maximum likelihood (ML), k-nearest, and the like, may be used as the pattern recognition algorithms.

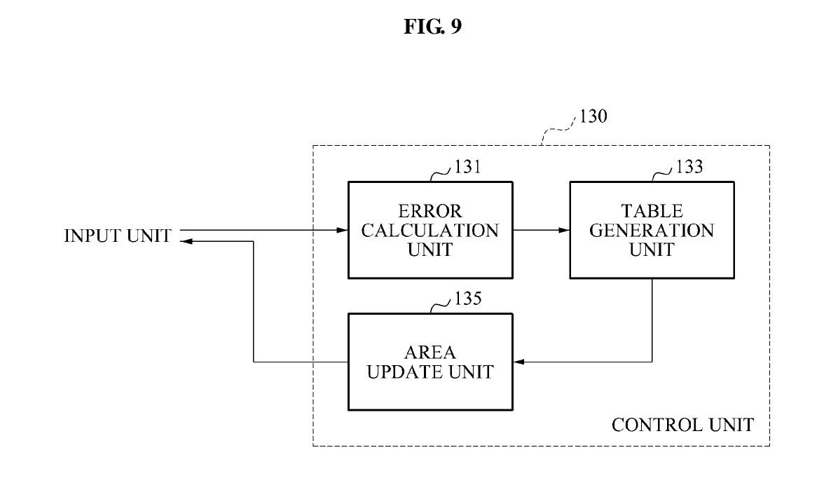

As another example, the control unit 130 may update the key area so that an average coordinate of the correct coordinates with respect to a predetermined key becomes a center of a key area. In this example, shapes of the key areas may be changed as in the foregoing examples or maintained as they are. Here, the control unit 130 may include an error calculation unit 131, a table generation unit 133, and an area update unit 135, as shown in FIG. 9.

FIG. 9 illustrates an example of a control unit of an input apparatus.

Referring to FIG. 9, the error calculation unit 131 of the control unit may calculate a relative coordinate (xr=xt−xk, yr=yt−yk) of an input coordinate (xt, yt) and a center coordinate (xk, yk) of a key area. The input coordinate (xt, yt) may be obtained and transferred by the input unit 110. The center coordinate (xk, yk) may correspond to a center of the key area that generates the same key code as the key code generated by the input coordinate (xt, yt). In this example, the error calculation unit 131 may calculate the relative coordinate by subtracting the center coordinate from the input coordinate.

The control unit may update the key area of the input unit 110 based on the relative coordinate calculated by the error calculation unit 131. To update the key area, the table generation unit 133 and the area update unit 135 may be used.

For example, the table generation unit 133 of the control unit may determine whether the key code generated by the input coordinate is corrected, and may add a corresponding relative coordinate to a distribution table if the key code is not corrected. The table generation unit 133 may determine the corrected state of the key code until an input is received indicating an end of inspection by the user with respect to input key codes, such as an enter key in a computer or a send key in a smart phone. As another example, if the correction is not performed until the end of use of the input apparatus, the key code may be determined as not being corrected.

The distribution table to which an uncorrected input coordinate is added may be a group of input coordinates that are based on respective keys. If a number of relative coordinates added to the distribution table satisfies a preset value, the area update unit 135 may determine an average of the relative coordinates added to the distribution table to be a new center coordinate (xk1, yk1). In this example, the area update unit 135 may move a center of the key area from the existing center coordinate (xk, yk) to the new center coordinate (xk1, yk1) while maintaining the shape of the existing key area. As another example, a boundary of the key area may be updated based on the input pattern recognized from the relative coordinates added to the distribution table.

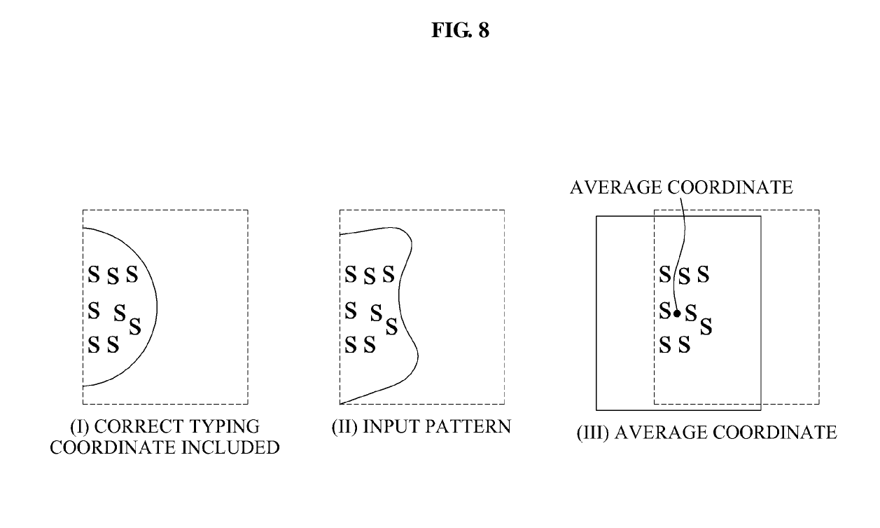

Update of the key area by the control unit 130 may be performed in various manners as illustrated with reference to FIG. 8. After the update is completed, boundaries of neighboring key areas may be separated from each other. In this example, if the user performs input at a portion between the separated boundaries, no key code may be output from the portion. To prevent such an occurrence, when the boundaries of the neighboring key areas are separated, the control unit 130 may expand at least one of the boundaries until the boundaries touch each other.

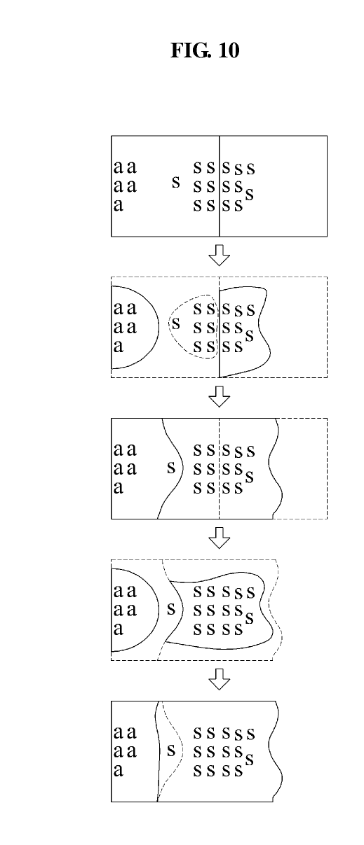

FIG. 10 illustrates an example of a process of expanding a boundary of a key area by a control unit in an input apparatus according to an embodiment of the present invention.

The top of FIG. 10 shows boundaries of key ‘a’ and key ‘s’ shown in FIG. 7. In a second drawing, the boundaries are separated after first update. For example, when the key area is updated using a correct typing coordinate, an input coordinate received to the key area of key ‘a’ among input coordinates input targeting key ‘s’ is caused by the incorrect typing. Accordingly, the input coordinate is not used for update but ignored. However, according to the pattern recognition algorithm, a boundary of the key area of the corresponding key may be expanded up to an area of a neighboring key. Accordingly, the update may be performed by including the ignored input coordinate. However, in an example in which breaking into the previously set area of the neighboring key is prevented, the boundaries of the neighboring keys may be separated as shown in FIG. 10.

The control unit may expand the boundaries until the separated boundaries touch each other. In FIG. 10, the boundary of key ‘a’ and the boundary of key ‘s’ are evenly expanded. As a result, part of the input coordinates of key ‘s’ which are ignored may be included in the key area of key ‘a’ as shown in a third drawing of FIG. 10. As update of the key area and expansion of the boundary are repeated, most if not all of the input coordinates input targeting key ‘s’ may be included in the key area of key ‘s’ as shown in fourth and fifth drawings of FIG. 10. Although FIG. 10 illustrates only key ‘a’ and key ‘s’ laterally arranged, for a convenient explanation, it should be appreciated that all boundaries of the key area neighboring in up and down directions and lateral directions may be modified. Therefore, the key area may be updated or expanded into a complicated closed curve shape.

In various examples, a method of updating a key area of a pressed key as intended by the user using a coordinate corresponding to the pressed key has been described. As another example, a key area of a key not intended by the user may be updated.

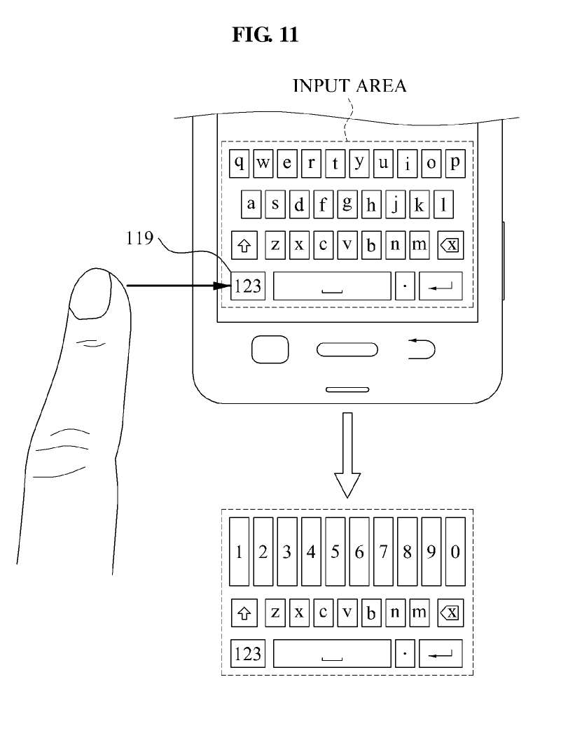

FIG. 11 illustrates an example of an operation of an input apparatus.

The input apparatus shown FIG. 11 may include an input unit and a control unit. According to an input coordinate received by the input unit, the control unit may update a key area of a key that is different from a key of which the input coordinate is received. The input unit may display only alphabet letters, for example, due to a limited space.

In this example, a function key 119 may be provided to enable input of other letters including numbers, signs, and the like. For example, if the function key 119 is pressed, numbers 1, 2, 3, 4, 5, 6, 7, 8, 9, and 0 may be displayed instead of the alphabetical letters q, w, e, r, t, y, u, i, o, and p as shown in FIG. 11.

In this example, the control unit may update key areas of the respective number keys being displayed, as shown in a lower drawing of FIG. 11. Here, the control unit may receive and analyze a pressed input coordinate of the function key 119, thereby recognizing the input pattern with respect to a corresponding function key. Therefore, the control unit may update the key area of other keys such as the number keys based on the input pattern of a user. The present example may be used to prevent waste of resources as well as displaying other keys using the function key.

For example, it may be difficult to recognize the input pattern with respect to all keys of the input apparatus. Therefore, the input pattern of the user may be recognized with respect to only a reference key and key areas of all keys may be updated based on the recognized input pattern of the particular reference key. This method may be applied when the input unit is used mostly by one finger.

When both hands are used to input to the input unit, key areas processed by any one hand may be updated by recognizing only an input pattern of the key areas. In this example, key areas processed by the other hand may be updated to be symmetrical to the former updated key areas, based on a principle that input patterns of both hands in the input unit are almost symmetrical.

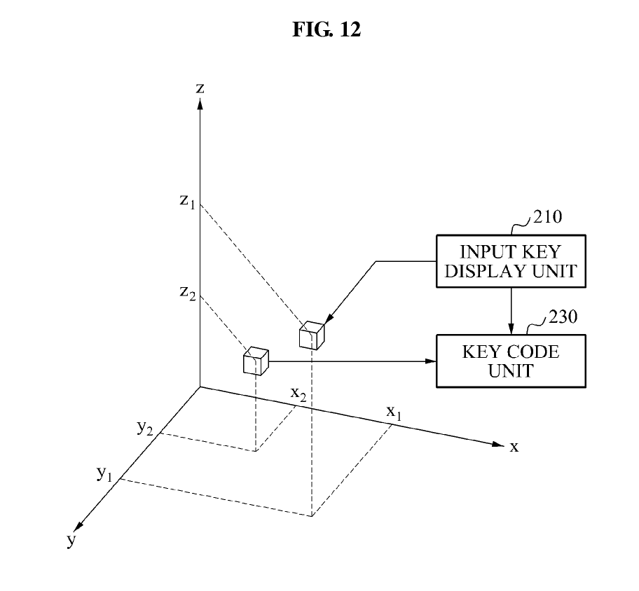

FIG. 12 illustrates another example of an operation of an input apparatus.

The input apparatus shown in FIG. 12 may be input with an input key from a manipulation area that is formed on a second coordinate which is different from a first coordinate displaying the input key in a display space. For example, the input apparatus may include an input key display unit 210 and a key code unit 230.

The display space may refer to a dimension displaying the input key and which includes the manipulation area. For example, the touch screen may be a two-dimensional (2D) display space or a three-dimensional (3D) space. The manipulation area refers to an area enabling manipulation of the user in the display space. The manipulation area may include an area displaying the input key.

The input key display unit 210 may display the input key in the display space. A group of input keys being displayed may constitute various types of a keyboard such as the qwerty keyboard and the like. The input key may be visually displayed to the user while enabling the user to manipulate an area of the input key being displayed. For example, a predetermined input key may be displayed with reference to a first coordinate (x₁, y₁, z₁) in a 3D display apparatus, and the user may manipulate the input key for example by touch.

In this example, depending on a shape of a tool such as a finger, a touch pen, and the like, or due to an optical illusion, a position other than the input key, with reference to a second coordinate (x₂, y₂, z₂) may be touched. Accordingly, incorrect typing may occur.

To reduce incorrect typing, the input key display unit 210 may not assign a key code to the input key. Instead, the key code may be assigned to the manipulation area disposed in the display space.

The key code unit 230 may dispose the manipulation area assigned with the key code of the input key, in another area different from the area of the input key in the display space. In this example, normal input may be achieved when the key code unit 230 disposes the manipulation area with reference to the second coordinate (x₂, y₂, z₂) in the display space.

To reduce incorrect typing, the manipulation area may be an area in which wrong manipulation is performed, that is, the second coordinate, during manipulation of the input key, that is, the first coordinate, by the user. A shape and size of the manipulation area may be the same as those of the area of the input key. For example, a position of the manipulation area may be experimentally determined. According to the present example, an input apparatus commonly used by many and unspecified users may be produced at high productivity.

In addition, the shape, size, and/or position of the manipulation area may be updated in such a manner to reduce incorrect typing. In this case, the input apparatus may be as shown in FIG. 4. In this example, an input apparatus optimized for an individual user may be provided.

The key code unit 230 may form the manipulation area in consideration of the shape, size, position, and array of the input key. For example, the key code unit 230 may receive various information about the input key from the input key display unit 210.

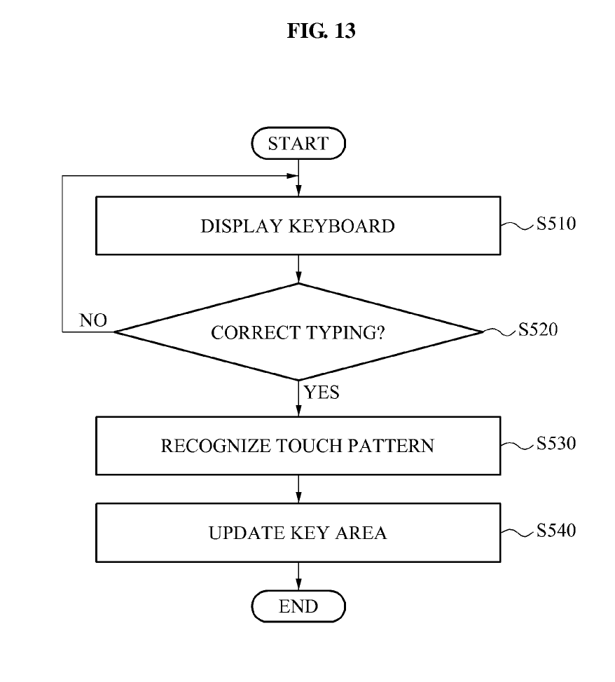

FIG. 13 illustrates an example of an input method.

In operation S510, a keyboard is displayed on a touch screen. This operation may be performed by the input unit 110 of the input apparatus shown in FIG. 1. Because the keyboard is displayed on the touch screen, the user may perform input using the displayed keyboard. For example, the keyboard may include a first keyboard displayed on the touch screen and a second keyboard including a key area to output a key code. In this example, the first keyboard may be displayed on the touch screen while a manipulation point of the user with respect to the first keyboard, that is, a touch position or input position, may be recognized by the second keyboard. The key code is also output.

In operation S530, a touch pattern is recognized from distribution of the touch position input by correct typing in operation S520 on the input area including the keyboard. In case of an incorrect typing, the control unit 130 does not use the touch position in recognizing the corresponding touch pattern.

According to the recognized touch pattern, the key area outputting the key code in the keyboard is updated in operation S540. For example, the control unit 130 may update the key area using various methods. Here, the update may be performed with respect to the keyboard displayed on the touch screen or an imaginary keyboard not displayed on the touch screen but assigned with the key code.

According to various aspects, because the key area outputting the key code is updated according to the touch pattern, incorrect typing may be reduced.

It will be apparent to those skilled in the art that various modifications and variation can be made without de-parting from the spirit or scope of the embodiments. Therefore, it should be understood that foregoing general illustrations and following detailed descriptions are not limiting but merely examples. For example, the input apparatus may be applied to a touch screen, a 3-dimensional (3D) input apparatus, and the like provided to various portable terminals. As another example, the input apparatus may include a reset feature to reset the settings of the input unit back to the original setting.

Various aspects herein may be used as an input device of various systems. For examples, the examples herein may be applied to a device which simultaneously performs display and input of the input device, such as a touch screen displayed as software and receiving input from a displayed key.

According to various aspects, it is possible to reduce an incorrect typing rate of a user by updating a key area provided to an input unit according to an input coordinate.

Program instructions to perform a method described herein, or one or more operations thereof, may be recorded, stored, or fixed in one or more computer-readable storage media. The program instructions may be implemented by a computer. For example, the computer may cause a processor to execute the program instructions. The media may include, alone or in combination with the program instructions, data files, data structures, and the like. Examples of computer-readable storage media include magnetic media, such as hard disks, floppy disks, and magnetic tape; optical media such as CD ROM disks and DVDs; magneto-optical media, such as optical disks; and hardware devices that are specially configured to store and perform program instructions, such as read-only memory (ROM), random access memory (RAM), flash memory, and the like. Examples of program instructions include machine code, such as produced by a compiler, and files containing higher level code that may be executed by the computer using an interpreter. The program instructions, that is, software, may be distributed over network coupled computer systems so that the software is stored and executed in a distributed fashion. For example, the software and data may be stored by one or more computer readable storage mediums. Also, functional programs, codes, and code segments for accomplishing the example embodiments disclosed herein can be easily construed by programmers skilled in the art to which the embodiments pertain based on and using the flow diagrams and block diagrams of the figures and their corresponding descriptions as provided herein. Also, the described unit to perform an operation or a method may be hardware, software, or some combination of hardware and software. For example, the unit may be a software package running on a computer or the computer on which that software is running.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. An input apparatus comprising:
an input unit comprising at least one key and configured to receive at least one input coordinate corresponding to the at least one key; and
a control unit configured to update a key area of the input unit based on the at least one input coordinate.

2. The input apparatus of claim 1, wherein
the input unit comprises a first input unit that is displayed on a screen and a second input unit that is not displayed on the screen,
the second input unit is configured to receive the at least one input coordinate, and
the control unit is configured to update the key area of the second input unit.

3. The input apparatus of claim 2, wherein
the first input unit comprises a keyboard displayed on a touch screen, and
the second input unit comprises a key area of a virtual key that is different in location from a key area of the at least one key of the first input unit, in an input area including the keyboard on the touch screen.

4. The input apparatus of claim 2, wherein the second input unit is configured to be selectively displayed on the screen.

5. The input apparatus of claim 1, wherein the control unit is configured to update the key area of the input unit based on a correct typing coordinate input by correct typing by the user.

6. The input apparatus of claim 5, wherein the correct typing coordinate comprises an input coordinate of an uncorrected key code from among the at least one input coordinates.

7. The input apparatus of claim 5, wherein the control unit is configured to update the key area of the input unit such that the correct typing coordinate is included in the key area.

8. The input apparatus of claim 5, wherein the control unit is configured to update the key area of the input unit based on an input pattern obtained by analyzing the correct typing coordinate.

9. The input apparatus of claim 5, wherein the control unit is configured to update the key area such that an average coordinate of the correct typing coordinates with respect to the key becomes a center of the key area.

10. The input apparatus of claim 1, wherein the control unit comprises:
an error calculation unit configured to calculate a relative coordinate (xr=xt−xk, yr=yt−yk) of an input coordinate (xt, yt) and a center coordinate (xk, yk) of the key area, the relative coordinate corresponding to a difference between the input coordinate (xt, yt) and the center coordinate (xk, yk), and
the control unit is configured to update the key area of the input unit based on the calculated relative coordinate.

11. The input apparatus of claim 10, further comprising:
a table generation unit configured to determine whether a key code generated by the input coordinate is corrected and to add the relative coordinate to a distribution table in response to the key code not being corrected; and
an area update unit configured to determine an average of relative coordinates added to the distribution table to be a new center coordinate (xk1, yk1) in response to a number of the relative coordinates added to the distribution table satisfying a preset value.

12. The input apparatus of claim 11, wherein the area update unit is configured to update a boundary of the key area based on an input pattern recognized from the relative coordinate added to the distribution table.

13. The input apparatus of claim 1, wherein the control unit is configured to expand at least one of a boundary of the key area and a boundary of a neighboring key area until the boundaries touch each other, in response to the boundaries not being separated from each other.

14. The input apparatus of claim 1, wherein the control unit is configured to update a key area of a key different from a key of which the input coordinate is received.

15. An input apparatus comprising:
an input key display unit configured to display an input key in a display space; and
a key code unit configured to set a manipulation area assigned to the key code of the input key at a different area from an area of the input key in the display space.

16. The input apparatus of claim 15, wherein the manipulation area is manipulated by an error during manipulation of the input key.

17. An input apparatus comprising:
an input unit comprising a key assigned with a key code and configured to output the key code assigned to the key in response to the key being input; and
a control unit configured to update a key area of the key based on an input coordinate of the key of which an uncorrected key code among output key codes is output.

18. An input method comprising:
displaying a keyboard on a touch screen;
recognizing a touch pattern from distribution of touched positions input by correct typing to an input area that includes the keyboard; and
updating a key area that outputs a key code of the keyboard based on the recognized touch pattern.

19. The input method of claim 18, wherein the keyboard comprises a first keyboard displayed on the touch screen and a second keyboard outputting the key code.
